(19) United States
(12) Patent Application Publication
(10) Pub. No.: US 2017/0234630 A1
(43) Pub. Date: Aug. 17, 2017

(54) Brazed Heat Exchanger and Manufacturing Process

(71) Applicant: Modine Manufacturing Company, Racine, WI (US)

(72) Inventor: Thomas Feldhege, Leinfelden-Echterdingen (DE)

(21) Appl. No.: 15/502,237

(22) PCT Filed: Aug. 6, 2015
(86) PCT No.: PCT/US2015/044029

§ 371 Date: Feb. 7, 2017

(30) Foreign Application Priority Data
Aug. 7, 2014 (DE) 10 2014 011 745.6

(51) Int. Cl. F28F 19/06; F28D 1/053; C22C 21/02; B60H 1/00; B23K 1/00; B23K 35/28; F25B 39/00; F28F 21/08

(52) U.S. Cl. CPC F28F 19/06; F25B 39/00; F28D 1/05366; F28F 21/084; B60H 1/00335; B23K 1/0012; B23K 35/286; C22C 21/02; F25B 39/04

(57) ABSTRACT

A brazed heat exchanger, for example a heat exchanger to be used in an air-conditioning system, preferably as a condenser, includes flat tubes extending between a pair of header tubes and fins arranged between the flat tubes. The components are produced from aluminum alloys, and are brazed together using an AlSi braze alloy. The aluminum alloys have a zinc content of no greater than 0.5% before brazing, and zinc from the aluminum alloys diffuses into the braze joints to result in braze joints having an average zinc content of no greater than 0.1%.

### CROSS REFERENCE TO RELATED APPLICATIONS

This application claims priority to German Patent Application No. 10 2014 011 745 filed Aug. 7, 2014, the entire contents of which are hereby incorporated by reference herein.

### BACKGROUND

The invention relates to a brazed heat exchanger for use in an air-conditioning system of a motor vehicle, having a block consisting of tubes, through which a refrigerant flows, and of fins, through which cooling air, for example, flows.

DE 10 2006 062 793 B4 discloses a method for producing a brazed heat exchanger. The physical features of the brazed heat exchanger, which are mentioned in the introduction, are also known per se therefrom. However, the heat exchanger is used as a cooling liquid radiator for cooling the drive train.

A flat tube for condensers which is produced from aluminum sheet strips is known, for example, from DE 10 2006 054 814 B4.

There are also brazed heat exchangers for use in air-conditioning systems which have extruded flat tubes. For technical reasons, flat tubes of this type do not have a braze coating or layer in the form of a braze plating. In these heat exchangers, the braze layer is usually located on the fins. Extruded tubes often also have a greater wall thickness (>0.25 mm), and therefore the weight of the heat exchanger is high. Although tubes having very thin walls can already be produced at present by means of extrusion, these still present a significant cost factor on account of the associated high technical outlay, lower production speeds, etc.

It has been ascertained that brazed heat exchangers such as condensers, gas coolers or evaporators which are present in an air-conditioning circuit and are in contact with a refrigerant are particularly susceptible to corrosion. The reasons for this are, for example, the arrangement thereof at the front of the motor vehicle, but also the fact that they are scarcely used in the cooler time of year, and therefore cannot warm up and duly dry up, i.e. they usually remain moist. The susceptibility to corrosion mainly affects the fins, but also and above all, the brazed connections between the fins and the tubes and also between the tube ends and the header tubes.

It is advantageous and also known to coordinate the electrochemical corrosion potentials of the connected components of the heat exchanger in such a way that the fins corrode first, since corrosion of the fins does not lead directly to a leakage. In addition, the tubes and the header tubes are thereby protected in electrochemical terms. Overly rapid corrosion of the fin-tube connections is, in turn, undesirable, at least in terms of efficient heat transfer, because poor or even ruptured brazed connections transfer only little heat, it being possible for even relatively large cohesive portions of fins to break away from the heat exchanger. Moreover, the electrochemical protective mechanism is not effective to the desired extent if electrically conductive brazed connections are no longer present to the required extent.

In practice, a zinc (Zn) content of approximately 1.5% by weight is typically provided in the fins of condensers, gas coolers or evaporators, it occasionally also being the case that Zn contents of up to 2.5% are present.

DE 60 200 818 T2, which describes a method for producing heat exchangers, highlights a predominantly positive action of zinc as a constituent of an aluminum alloy.

DE 10 2004 048 954 A1 describes another method for producing heat exchangers, specifically also condensers. Here, use is made of a brazing material which contains a considerable amount of zinc.

DE 19 515 909 C2 proposes a zinc brazing method for brazed heat exchangers consisting of aluminum parts, in which a brazing flux is admixed to a zinc bath. The heat exchangers can be dipped into the bath or can be sprayed with the mixture. The heat exchangers produced are supposedly those which are to be found in air-conditioning systems.

Further prior art becomes apparent from DE 20 2011 101 606 U1. In said document, zinc present in a coating is regarded as advantageous in terms of improving the corrosion resistance.

By way of example, DE 69 818 448 T2 discloses an aluminum-lithium alloy which—in contrast to the four publications mentioned—is substantially free of zinc. It is assumed in said document that zinc has a disadvantageous influence on the mechanical properties of the AlLi alloy.

### SUMMARY

It is an object of the invention to improve the corrosion behavior of the brazed heat exchanger and to provide an advantageous production method therefor.

This object is achieved by a brazed heat exchanger for exclusive or at least for very preferable use in an air-conditioning system, such as a condenser, as described herein. The production method according to some embodiments of the invention is specified.

The heat exchanger according to some embodiments of the invention consists of aluminum alloys which are modified in respect of the zinc content. The Zn content should be virtually zero, apart from technically unavoidable impurities containing zinc. The Zn content which is absent in comparison with the prior art is preferably replaced by pure aluminum.

The fins preferably consist of modified AA 3003 or 3103—in some cases also from the group AA 1000. The thickness of the fins lies in the range of between 30 and 100 μm.

The AlSi braze coating or layer preferably originates from the AA 4000 alloy group, preferably from modified AA 4343 or AA 4045.

The tubes, preferably flat tubes, consist of what is termed a long life aluminum alloy from the group AA 3XXX, i.e. an aluminum-manganese alloy. The preferred wall thickness of the flat tubes is 0.20 mm or smaller, but can be between 0.20 mm and 0.45 mm.

The header tubes similarly consist of a long life aluminum alloy from the group AA 3XXX, i.e. an aluminum-manganese alloy. They preferably have a wall thickness in the range of approximately 0.5-2.0 mm.

Long life aluminum alloys are alloy modifications/developments, preferably from the classes AA 3003 or AA 3103, in which, from a defined material state prior to the brazing, a surface layer is formed by silicon diffusion in the course of the brazing, said surface layer consisting of densely distributed precipitations and making the surface layer less noble in electrochemical terms than a core layer not affected by Si diffusion, and therefore said surface layer is sacrificed and hence better protects the core layer. The depth of penetration or the thickness of the surface layer can be determined by way of the Si content. The duration and the temperature of the brazing process also have an influence on the depth of penetration. A relatively long brazing duration leads to greater depths of penetration. An Si content of 6.8-12% in the AlSi braze layer is a suitable order of magnitude. Silicon reduces the melting point of the AlSi braze layer somewhat. The braze layer melts before the underlying aluminum layer does.

The inventor has established that the presence of zinc (Zn) is the cause of the excessively fast corrosion, and therefore strives to achieve the greatest possible freedom of the components from Zn.

It has also been found that zinc added intentionally to the alloy or present in the form of alloy impurities is enriched locally in zones in which this is not desired in the course of the brazing process. The zinc diffuses into these zones. Furthermore, the flow of braze which is intentional and is present in the course of the brazing process proceeding in a brazing furnace leads to the spread of Zn into the zones. Zones of this nature are within the brazed connection joints. These therefore undergo corrosion more quickly than should be the case. In order to slow the corrosion process down, a Zn enrichment of on average not more than 0.1% is present in the brazed joints after brazing according to the invention. The production method according to the invention is directed to this.

The Zn content of max. 0.1% represents—as mentioned—an average value. In practice, the enrichment does not have a uniform distribution. There are local regions within the brazed joints which have a relatively high Zn concentration. In the prior art, the Zn concentration in some regions is so high that these constitute starting points for corrosion. The invention largely avoids this.

An embodiment according to the invention has succeeded in satisfying the most recent corrosion test requirements for a condenser, the 55-day SWAAT test (Sea Water Acetic Acid Test); this has not been achieved even closely with a condenser commercially available to date. The integrity of the tube-fin brazed connection was improved to a particular extent.

The proposed heat exchanger has been balanced very well in respect of the electrochemical voltage potentials between the fins, the tubes and the header tubes. Each component contains—as mentioned—less than or not more than 0.05% zinc before the brazing. Since the brazed connection joints which form during the brazing process also merely have an average zinc content of max. 0.1%, they are not exposed to such rapid corrosion on account of their electrochemically more positive potential.

Herein below, the invention will be described in an exemplary embodiment with reference to the attached three figures.

### BRIEF DESCRIPTION OF THE FIGURES

FIG. 1 is a simplified partial, cross-sectional view of select components of a heat exchanger according to an embodiment of the invention prior to brazing.

FIG. 2 is the same as FIG. 1, but after brazing.

FIG. 3 is a diagrammatic representation of the material structure through a braze joint of the heat exchanger of FIG. 2.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

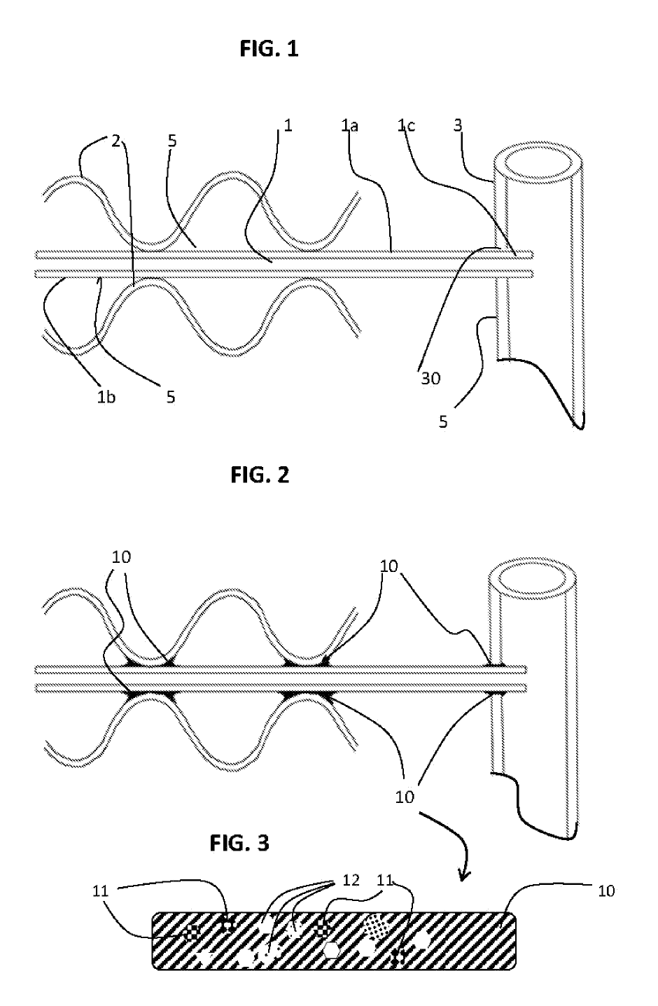

FIG. 1 shows part of a single tube 1 of a heat exchanger, in particular a flat tube, in cross-section along one of two narrow sides of the flat tube 1, having two fins 2 arranged on two broad sides 1a, 1b thereof, on the top and on the bottom. FIG. 1 also shows only one of two tube ends 1c, which sits in an opening 30 in a header tube 3 (shown only partially and in partial cross-section). The second header tube 3 is located in an identical manner at the other flat tube end 1c (not shown). FIG. 2 shows roughly the same image, but after the conclusion of a CAB brazing process in a brazing furnace, or after the formation of corresponding brazed joints 10. FIG. 3 shows a section from a cross-section of a brazed joint 10 in purely abstract form, which includes regions 11, 12 that form during brazing and have a relatively high and a relatively low Zn concentration, respectively.

The flat tubes 1 and the fins 2 form a block consisting of alternating flat tubes 1 and fins 2, in which flat tubes 1 are joined to fins 2. The opposing tube ends 1c of the flat tubes 1 are located in the openings 30 in the header tubes 3, which extend perpendicular to the flat tubes 1.

The brazed heat exchanger is intended for use in an air-conditioning system in a motor vehicle, preferably as a condenser. A refrigerant flows through the flat tubes 1 of the block. Cooling air flows through the fins 2 of the block perpendicular to the plane of the figures.

The flat tubes 1 of the exemplary embodiment have been produced from two or from three sheet strips coated with a braze coating or layer 5—one of the sheet strips being formed into a duct forming tube insert, as is shown and described in the DE document cited second in the introduction.

Embodiments in which the flat tubes have been produced from a single sheet strip are also possible.

In further exemplary embodiments, which are not shown, extruded multi-chamber flat tubes 1 are present. In this case, an AlSi braze layer 5 has been applied to the flat tubes 1 by a spraying method, for example. In other embodiments of this type, the flat tubes 1 remain without a braze coating or layer 5, which is then located on the fins 2. In these cases, the braze required for the connections 10 of the flat tube ends 1c in the openings 30 is present in a sufficient quantity as an AlSi braze layer 5 on the header tubes 3.

All component parts of the heat exchanger consist of suitable aluminum alloys. The AlSi braze coating/layer 5 which has been modified in respect of a Zn content but is otherwise known per se is located on the surface of the header tubes 3 and of the flat tubes 1. The fins 2 in the exemplary embodiment do not have a braze coating/layer 5.

The average Zn content in the aluminum alloy of the fins 2, of the flat tubes 1, of the header tubes 3 and in the AlSi braze layer 5 on the flat tubes 1 and the header tubes 3 is 0.00 to ≦0.05% before the brazing.

By contrast, an average Zn content of 0.00-max. 0.1% is present in the brazed connection joints 10, as depicted in FIG. 2.

The Zn content in the brazed joints 10 is not uniformly distributed. There are local regions 11 having a relatively high Zn concentration and other regions 12 having a relatively low Zn concentration. It cannot be ruled out that some regions 11 having a relatively high Zn concentration also have a Zn content lying slightly above 0.1%. The formation of the local regions 11, 12 is also not foreseeable in terms of their local distribution in the brazed joints 10 and in terms of their shape and size, as depicted in FIG. 3. Since the average Zn content thereof has been reduced to a significantly, the susceptibility of the heat exchanger to corrosion has been reduced considerably.

The aluminum alloy of the fins preferably consists of modified AA 3003 or AA 3103. The fins 2 have an electrochemical corrosion potential of approximately in the range of −750 to −700 mV.

The electrochemical corrosion potentials are determined, for example, by a method described in ASTM-G69 (American Society of Testing and Materials).

The header tubes 3 consist of an aluminum long life material. They have a core layer (not shown) of modified AA 3003 or AA 3103 and a silicon-containing surface layer, with an electrochemical voltage potential difference of 0.00 to +20 mV between the aforementioned layers.

The aluminum alloy of the flat tubes 1 consists of long life material of modified AA 3003, and it has a voltage potential difference of 0.00 to +20 mV with respect to the fins 2.

The different voltage potentials are formed by corresponding alloying constituents, such as for example Cu, Mn or Mg. These and other alloying constituents are known to hide behind the aforementioned alloy classifications AA. The silicon diffusion already mentioned above likewise contributes to the reduction of the voltage potential through the formation of precipitations.

The addressed values of the voltage potentials refer to a state after the brazing.

The AlSi braze layer 5 is of the AA 4343 or AA 4045 type. It has an Si content of approximately 6.8-12%.

The fins 2 have a thickness of between 30 and 100 μm.

The flat tubes 1 are normally significantly thicker; they have a wall thickness of 0.20 mm or smaller.

In the course of the brazing process, zinc present as an impurity of the aluminum alloys and in the AlSi braze coating(s)/layer(s) 5 is enriched in the brazed connection joints 10. An average Zn content of up to approximately 0.1% is present in the brazed joints 10 after the brazing process.

Various alternatives to the certain features and elements of the present invention are described with reference to specific embodiments of the present invention. With the exception of features, elements, and manners of operation that are mutually exclusive of or are inconsistent with each embodiment described above, it should be noted that the alternative features, elements, and manners of operation described with reference to one particular embodiment are applicable to the other embodiments.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention.

What is claimed is:

1. A brazed heat exchanger comprising:
a pair of spaced apart header tubes constructed of a first aluminum alloy;
a plurality of flat tubes constructed of a second aluminum alloy, each of the flat tubes extending between the pair of spaced apart header tubes and having a first end joined to the first header tube and a second end joined to the second header tube by way of braze joints; and
a plurality of fins constructed of a third aluminum alloy arranged between the flat tubes and joined to broad sides of the flat tubes by way of braze joints;
wherein each of the first, second, and third aluminum alloys have an average Zn content of no greater than 0.05% before the creation of the braze joints.

2. The brazed heat exchanger of claim 1, wherein the braze joints have an average Zn content of no greater than 0.1%.

3. The brazed heat exchanger of claim 2, wherein the Zn content of the braze joints is not uniformly distributed throughout the braze joints.

4. The brazed heat exchanger of claim 1, wherein the third aluminum alloy has a electrochemical corrosion potential between −750 mV and −700 mV.

5. The brazed heat exchanger of claim 1, wherein the third aluminum alloy is less noble than the second aluminum alloy.

6. The brazed heat exchanger of claim 5, wherein the difference in electrochemical corrosion potential between the second and third aluminum alloys is no greater than 20 mV.

7. The brazed heat exchanger of claim 1, wherein the first aluminum alloy is a long life alloy comprising a core layer and a surface layer formed by silicon diffusion during the course of brazing.

8. The brazed heat exchanger of claim 7, wherein the surface layer is less noble than the core layer.

9. The brazed heat exchanger of claim 8, wherein the difference in electrochemical corrosion potential between the surface layer and the core layer is no greater than 20 mV.

10. The brazed heat exchanger of claim 1, wherein the braze joints are formed from an AlSi braze layer applied to the pair of headers and to the plurality of flat tubes or the plurality of fins or both.

11. The brazed heat exchanger of claim 10, wherein the AlSi braze layer has an average Zn content of no greater than 0.05% before the creation of the braze joints.

12. The brazed heat exchanger of claim 11, wherein the Si content of the AlSi braze layer is between 6.8% and 12%.

13. The brazed heat exchanger of claim 1, wherein the plurality of fins have a material thickness between 30 and 100 μm.

14. The brazed heat exchanger of claim 13, wherein the plurality of flat tubes have a wall thickness of no greater than 0.20 mm.

15. A method of manufacturing a heat exchanger comprising:
assembling a pair of header tubes, a plurality of flat tubes, and a plurality of fins to form a heat exchanger core assembly, each of the header tubes, flat tubes, and fins being formed from an aluminum alloy having an average Zn content of no greater than 0.05%;
heating the heat exchanger core assembly to a brazing temperature sufficient to melt and flow an AlSi braze coating applied to the pair of headers and to the plurality of flat tubes or the plurality of fins or both;
maintaining the heat exchanger core assembly at the brazing temperature for a period of time sufficient to create a Si diffusion surface layer on the header tubes; and
cooling the heat exchanger core assembly to create braze joints between the pair of header tubes and the plurality of flat tubes, and between the plurality of flat tubes and the plurality of fins.

16. The method of claim 15, further comprising diffusing Zn from the aluminum alloys into the braze joints to form local areas of Zn enrichment within the braze joints.

17. The method of claim 16, wherein the step of diffusing Zn results in an average zinc content of the braze joints of not greater than 0.1%.

18. An air-conditioning system including a condenser, the condenser comprising,
a plurality of tubes, each of the plurality of tubes including two opposing broad sides and two opposing narrow sides, two opposing ends, and a tube wall having a first long life aluminum alloy layer and a first braze layer;
two headers, each header including a header wall having a second long life aluminum alloy layer and a second braze layer; and
a plurality of fins,
wherein each of the plurality of tubes is arranged between the two headers, such that each of the two opposing ends of each of the plurality tubes is brazed to one of the headers,
wherein at least one of the fins is located between and brazed to two of the plurality of tubes by the first braze layer of each of the two of the plurality of tubes, and
wherein each of the first long life aluminum alloy layer, the second long life aluminum alloy layer, the first braze layer, and the second braze layer have an average Zn content of no greater than 0.05%.

19. The condenser of claim 18, wherein each of the plurality of tubes further comprises at least two sheet strips, and one of the at least two sheet strips is a tube insert defining ducts inside of the tube.

20. The condenser of claim 19, wherein at least one of the two sheet strips includes the first long life aluminum alloy layer and the first braze layer.
